(19) United States
(12) Patent Application Publication
(10) Pub. No.: US 2026/0330582 A1
(43) Pub. Date: Oct. 22, 2026

(54) INTERNET OF THINGS LARGE MODEL SYSTEMS AND METHODS FOR EMERGENCY SUPERVISION OF PAVEMENT COLLAPSE IN SMART CITY

(71) Applicant: CHENGDU QINCHUAN IOT TECHNOLOGY CO., LTD., Chengdu (CN)

(72) Inventors: Hanshu SHAO, Chengdu (CN); Junyan ZHOU, Chengdu (CN)

(73) Assignee: CHENGDU QINCHUAN IOT TECHNOLOGY CO., LTD., Chengdu (CN)

(21) Appl. No.: 19/691,982

(22) Filed: May 29, 2026

(30) Foreign Application Priority Data
May 6, 2026 (CN) 202610607808.9

(51) Int. Cl. G06Q 50/26; G05D 1/648; G05D 105/80; G08G 1/087; G16Y 40/50

(52) U.S. Cl. CPC G06Q 50/265; G05D 1/6486; G08G 1/087; G16Y 40/50; G05D 2105/87; G05D 2105/89; G06Q 2240/00

(57) ABSTRACT

The present disclosure relates to the field of emergency supervision of pavement collapse and provides an Internet of Things large model system and method for emergency supervision of pavement collapse in a smart city. The system includes an emergency supervision management platform. The emergency supervision management platform is configured to: obtain multi-source monitoring data via an emergency supervision object platform; determine a collapse risk distribution of a target road section based on the multi-source monitoring data; determine exploration parameters based on the collapse risk distribution; control a GPR of the emergency supervision object platform to perform exploration on the target exploration point based on the exploration parameters and obtain exploration data; determine whether geological hazard features exist at the target exploration point based on the exploration data; and in response to determining that the geological hazard features exist at the target exploration point, generate a traffic control instruction and send the traffic control instruction to the emergency supervision object platform to control a barrier gate of an associated road of the target exploration point to rise.

### CROSS-REFERENCE TO RELATED APPLICATIONS

This application claims priority to Chinese Patent Application No. 202610607808.9, filed on May 6, 2026, the contents of each of which are hereby incorporated by reference.

### TECHNICAL FIELD

The present disclosure relates to the field of road surface supervision, and in particular, to an Internet of Things large model system and a method for emergency supervision of pavement collapse in a smart city.

### BACKGROUND

Under the action of traffic load or geological disturbance, an urban underground pipeline network is highly prone to causing subsidence or collapse of an urban road surface, resulting in property loss and casualties. Currently, in urban collapse risk monitoring, abnormal identification usually relies on a single type of data (such as surface subsidence or pipeline network flow), making it difficult to accurately determine the spatial location, scale, and development trend of underground cavities or pipeline damage under conditions of no excavation and no underground sensors.

Therefore, it is desirable to provide a Internet of Things large model system and a method for emergency supervision of pavement collapse in a smart city to improve the accuracy of determining the location, size, and development trend of a potential pavement collapse.

### SUMMARY

One or more embodiments in the present disclosure provide a Internet of Things large model system for emergency supervision of pavement collapse in a smart city, the system comprises: an emergency supervision user platform; an emergency supervision service platform; an emergency supervision management platform; an emergency supervision sensor network platform; and an emergency supervision object platform, wherein the emergency supervision management platform is configured to: obtain multi-source monitoring data through the emergency supervision object platform; determine a collapse risk distribution of a target road section based on the multi-source monitoring data; determine exploration parameters based on the collapse risk distribution, wherein the exploration parameters include a target exploration point and a working frequency set; control a vehicle-mounted ground penetrating radar (GPR) of the emergency supervision object platform to perform exploration on the target exploration point based on the exploration parameters, and collect exploration data; determine whether the geological hazard feature exists at the target exploration point based on the exploration data; and if the geological hazard feature exists at the target exploration point, generate a traffic control instruction, and send the traffic control instruction to the emergency supervision object platform to control a barrier gate of an associated road of the target exploration point to rise.

One or more embodiments of the present disclosure provide a method for emergency supervision of pavement collapse in a smart city. The method is performed by an emergency supervision management platform in an Internet of Things large model system for emergency supervision of pavement collapse in a smart city. The method includes: obtaining multi-source monitoring data via an emergency supervision object platform; determining a collapse risk distribution of a target road section based on the multi-source monitoring data; determining exploration parameters based on the collapse risk distribution, the exploration parameters including a target exploration point and a working frequency set; controlling a vehicle-mounted ground penetrating radar (GPR) of the emergency supervision object platform to perform exploration on the target exploration point based on the exploration parameters and obtain exploration data; determining whether geological hazard features exist at the target exploration point based on the exploration data; and in response to determining that the geological hazard features exist at the target exploration point, generating a traffic control instruction and sending the traffic control instruction to the emergency supervision object platform to control a barrier gate of an associated road of the target exploration point to rise.

### BRIEF DESCRIPTION OF THE DRAWINGS

Further details of the present disclosure will be illustrated by way of exemplary embodiments, which are described in detail with reference to the accompanying drawings. These embodiments are non-limiting, and in these embodiments, the same reference numerals denote the same structures, wherein:

FIG. 1 is a schematic diagram illustrating a platform structure of an Internet of Things large model system for emergency supervision of pavement collapse in a smart city according to some embodiments of the present disclosure;

FIG. 2 is a flowchart illustrating an exemplary process for emergency supervision of pavement collapse in a smart city according to some embodiments of the present disclosure;

FIG. 3 is a schematic diagram illustrating an exemplary collapse risk model according to some embodiments of the present disclosure;

FIG. 4 is a schematic diagram illustrating an exemplary process for determining exploration parameters according to some embodiments of the present disclosure.

### DETAILED DESCRIPTION

To more clearly illustrate the technical solutions of the embodiments of the present disclosure, the accompanying drawings to be used in the description of the embodiments are briefly introduced below. The accompanying drawings do not represent all embodiments.

Unless the context clearly indicates otherwise, the words “a,” “an,” “one,” and/or “the” are not limited to the singular and may also include the plural. Generally speaking, the terms “comprises” and “includes” only indicate the inclusion of specifically identified steps and elements, and these steps and elements do not constitute an exclusive list, and a method or an apparatus may also include other steps or elements.

In the embodiments of the present disclosure, when operations are described as being performed step by step, unless otherwise specified, the order of the steps is interchangeable, the steps may be omitted, and other steps may also be included during the operation.

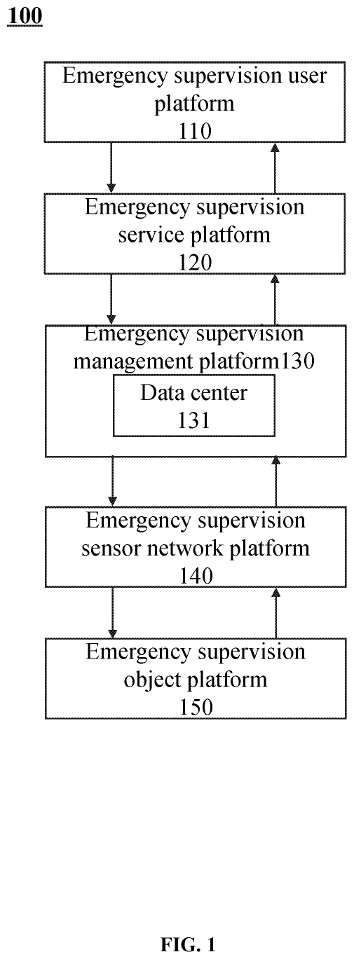

FIG. 1 is a schematic diagram illustrating a platform structure of an Internet of Things large model system for emergency supervision of pavement collapse in a smart city according to some embodiments of the present disclosure.

The Internet of Things large model in the IoT large model system may be a model architecture constructed based on the Internet of Things, used for realizing efficient operation of a large amount of data in the system. Meanwhile, a plurality of large models (such as a general large model, an industry large model, a lightweight large model, and a multi-modal large model) may be applied to the Internet of Things large model to assist the Internet of Things large model in sensing and processing data.

In some embodiments, as shown in FIG. 1, the Internet of Things large model system 100 for emergency supervision of pavement collapse in the smart city includes an emergency supervision user platform 110, an emergency supervision service platform 120, an emergency supervision management platform 130, an emergency supervision sensor network platform 140, and an emergency supervision object platform 150.

The emergency supervision user platform 110 refers to a platform for interacting with a user (such as supervision personnel). In some embodiments, the emergency supervision user platform 110 includes a terminal device. For example, the terminal device includes a mobile device, a tablet computer, and a console.

The emergency supervision service platform 120 refers to a platform for receiving and transmitting data and/or information. In some embodiments, the emergency supervision service platform 120 is configured as a server or a processor. The emergency supervision service platform 120 interacts bidirectionally with the emergency supervision user platform 110 and the emergency supervision management platform 130.

The emergency supervision management platform 130 refers to a comprehensive management platform for managing and coordinating the connections and collaborations among the plurality of platforms. In some embodiments, the emergency supervision management platform 130 is configured as a server or a processor. The emergency supervision management platform 130 interacts bidirectionally with the emergency supervision service platform 120 and the emergency supervision sensor network platform 140.

In some embodiments, the emergency supervision management platform 130 includes a data center 131. The data center 131 is configured to store data, information, or instructions generated or received by the emergency supervision management platform 130. The data center 131 includes a model library. The emergency supervision management platform 130 may invoke a plurality of models or large models via the model library.

The emergency supervision sensor network platform 140 refers to a platform for comprehensively managing sensing information. In some embodiments, the emergency supervision sensor network platform 140 is configured as a communication network or a gateway.

The emergency supervision object platform 150 refers to a platform for generating sensing information and executing control instructions. In some embodiments, the emergency supervision object platform 150 includes an unmanned aerial vehicle (UAV), a vehicle-mounted ground penetrating radar (GPR), and road facilities (such as a barrier gate, a warning device, and a height limiting frame). The emergency supervision object platform 150 interacts bidirectionally with the emergency supervision sensor network platform 140. The UAV is configured to obtain a surface image of the target road section.

The GPR may be a radar device for exploring internal structures and defects of non-visible areas under a pavement. In some embodiments, the GPR may emit high-frequency electromagnetic waves (such as 900 MHz), medium-frequency electromagnetic waves (such as 400 MHz), and low-frequency electromagnetic waves (such as 100 MHz).

The barrier gate is used to limit vehicle traffic on a road. The height limiting frame is used to limit the height of vehicles that can pass on a road. The warning device is used to issue warning information to vehicle drivers on the road, and includes a display screen and a broadcasting device.

In some embodiments, the road facilities may be deployed at locations such as along roads or at intersections.

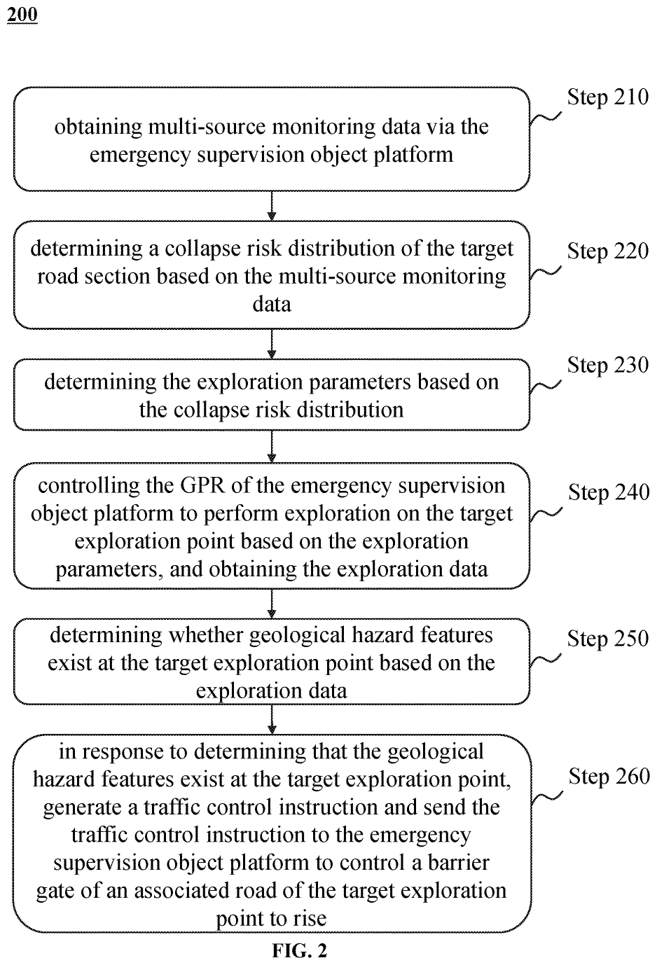

More descriptions of above contents can be found in FIGS. 2 to 4 and related descriptions thereof.

In some embodiments of the present disclosure, through the IoT large model system 100, an information operation closed loop may be formed among the functional platforms, and the system may operate in a coordinated and regular manner under the unified management of the emergency supervision management platform, to realize informatization and intellectualization of urban pavement collapse emergency supervision.

FIG. 2 is a flowchart illustrating an exemplary process for emergency supervision of pavement collapse in a smart city according to some embodiments of the present disclosure. In some embodiments, a process 200 for emergency supervision of pavement collapse in the smart city is performed by the emergency supervision management platform (hereinafter referred to as the management platform) in the IoT large model system for emergency supervision of pavement collapse in the smart city. As shown in FIG. 2, the process 200 includes the following steps:

Step 210, obtaining multi-source monitoring data via the emergency supervision object platform.

The multi-source monitoring data refers to a plurality of types of data for monitoring road-related conditions. In some embodiments, the multi-source monitoring data may include pipeline network operation data, soil data, traffic load data, or the like. After the target road section is determined, the management platform may only obtain the multi-source monitoring data corresponding to the target road section. More descriptions of the target road section may be found in step 220 and related descriptions.

The pipeline network operation data refers to data related to underground pipeline networks, such as underground water supply, drainage, and gas. For example, the pipeline network operation data includes pressure and flow inside pipelines, or the like.

The soil data refers to data related to the soil beneath the pavement. For example, the soil data includes the water content of the soil, the pore water pressure, the soil stress, or the like.

The traffic load data refers to data related to traffic conditions above the pavement. For example, the traffic load data includes the traffic flow, the driving speed, the vehicle types, and the vehicle loads of vehicles driving on the pavement, or the like.

In some embodiments, the management platform may obtain the multi-source monitoring data via the emergency supervision object platform. For example, the emergency supervision object platform obtains the pipeline network operation data and the soil data via sensors (e.g., humidity sensors, pressure sensors, pore water manometers, settlement displacement sensors, and flow sensors, or the like) disposed in a pipeline network and buried in soil, and uploads the pipeline network operation data and the soil data to the management platform.

In some embodiments, the management platform may also obtain the traffic load data from third-party platforms, such as map service providers or public transportation operation platforms.

In some embodiments, the multi-source monitoring data may also include surface deformation data.

The surface deformation data refers to data representing a micro-deformation of the pavement. In some embodiments, the surface deformation data includes settlement displacement values and settlement rates of the plurality of monitoring points within the monitoring cycle, or the like. The plurality of monitoring points and the monitoring cycle (e.g., one year) are preset based on historical experience. The micro-deformation may be that the settlement displacement values and the settlement rates are both millimeter-level.

The settlement displacement value refers to a displacement amount of settlement of a monitoring point relative to a reference point in a vertical direction. The reference point may be a fixed point that does not undergo displacement in a vertical direction.

The settlement rate refers to a speed at which a monitoring point undergoes settlement.

In some embodiments, the management platform may obtain the surface deformation data via manners such as satellite Synthetic Aperture Radar Interferometry, or the like. For example, the management platform performs Synthetic Aperture Radar imaging on the monitoring points via a satellite at a start time and an end time of the monitoring cycle. The management platform performs interferometric processing on radar wave phase information of the two Synthetic Aperture Radar images, determines a distance from the monitoring points to the satellite during the two imaging operations, and takes the difference between the distance corresponding to the start time and the distance corresponding to the end time as the settlement displacement value.

In some embodiments, the management platform may determine a ratio of the settlement displacement values of the monitoring points to the duration of the monitoring cycle within the monitoring cycle, to obtain the settlement rates of the monitoring points.

In some embodiments of the present disclosure, incorporating millimeter-level settlement displacement values and settlement rates into multi-source monitoring realizes early and large-scale general surveys of micro-deformations of the ground surface, thereby providing a basis for determining areas with collapse risk.

Step 220, determining a collapse risk distribution of the target road section based on the multi-source monitoring data.

The target road section refers to a road section that needs pavement collapse assessment. In some embodiments, the target road section may be preset.

In some embodiments, the management platform may also determine historical collapse cases based on historical disaster data, road monitoring data, and a road construction log, and determine the target road section based on the historical collapse cases.

The historical disaster data refers to information related to pavement collapses that occurred in historical time. In some embodiments, the historical disaster data includes locations, times, morphological features, and causes of pavement collapses that occurred in historical time, or the like. The morphological features of the pavement collapses include depths, diameters, areas, and shapes of collapse pits, or the like. The causes of the pavement collapses include burst water pipes, illegal construction, or heavy rain weather, or the like. The historical disaster data is stored in the historical disaster database of the data center.

The historical disaster database refers to a structured database for storing and managing detailed information of occurred pavement collapse events.

The road monitoring data refers to image data related to pavement collapse. For example, the road monitoring data includes video recordings before and after the pavement collapse. In some embodiments, the emergency supervision object platform obtains the road monitoring data via image acquisition devices on both sides of a road and uploads the road monitoring data to the processor.

The road construction log is configured to record information related to road and underground pipeline construction. For example, the road construction log includes locations, times, and excavation depths of construction, or the like. The road construction log is stored in the management platform.

The historical collapse case refers to a complete information set of a historical pavement collapse event. For example, the historical collapse case includes a location, a time, morphological features, causes, the corresponding road monitoring data, and the road construction log at the corresponding time of the historical pavement collapse event, or the like.

In some embodiments, the management platform may retrieve pavement collapse events that occurred in historical time based on the historical disaster data. The management platform takes each pavement collapse event as a historical collapse case, and records the historical disaster data, the road monitoring data, and the road construction log corresponding to the pavement collapse event in the corresponding historical collapse case.

In some embodiments, the management platform may count, among a plurality of historical collapse cases, a location with the most collapse occurrences within a preset historical period (e.g., past 2 years). The management platform takes an area where the location is located as a target area and determines all the roads within the target area as the target road section. The target area may be a circular range formed with the location with the most collapse occurrences as a center and with a preset radius (e.g., 1 kilometer) as a radius.

In some embodiments of the present disclosure, integrating the historical collapse cases to determine high-risk target road sections enables more specific determination of the target road sections based on the integration of actual collapse experience and data.

The collapse risk distribution may characterize a distribution of collapse risk of a plurality of road section units within the target road section. The collapse risk refers to a possibility that the pavement collapses.

The road section unit refers to a preset divided road section within the target road section. In some embodiments, the management platform may determine a pavement corresponding to a standard pipeline segment as a road section unit.

The standard pipeline segment may be a segment of pipeline in the underground pipeline network corresponding to the target road section. In some embodiments, the management platform, based on the underground pipeline network corresponding to the target road section, uses manholes in the underground pipeline network as division points, and takes the pipeline segment between two manholes as a standard pipeline segment.

Since the target road section includes a plurality of road section units, the management platform can obtain the multi-source monitoring data corresponding to each road section unit.

In some embodiments, the management platform can determine the collapse risk distribution of the target road section based on the multi-source monitoring data. For example, for each road section unit, the management platform can construct a target feature vector based on the multi-source monitoring data corresponding to the road section unit, determine the vector similarity between a plurality of reference feature vectors in the vector database and the target feature vector, and sort them from high to low. Then, based on averaging the labels corresponding to the reference feature vectors satisfying the matching conditions, the collapse risk of the road section unit is determined. The matching conditions include being among the top k in the vector similarity sorting, where k is a preset value (such as 3). Vector similarity is negatively correlated with vector distance, and vector distance includes Euclidean distance.

In some embodiments, the vector database can be preset based on historical data. For example, the management platform constructs a plurality of reference feature vectors based on the multi-source monitoring data corresponding to a plurality of historical road section units and determines the label of the reference feature vectors based on whether the historical road section units experienced collapse. The management platform sets the label of the historical road section units that experienced collapse to 1 and sets the label of the historical road section units that did not experience collapse to 0.

In some embodiments, the management platform may average the labels corresponding to the reference feature vectors satisfying the matching conditions, thereby obtaining the collapse risk of a single road section unit. The management platform determines and combines the collapse risks of the plurality of road section units by the above-described manner to obtain the collapse risk distribution.

Step 230, determining the exploration parameters based on the collapse risk distribution.

The exploration parameters refer to parameters for guiding the GPR to perform exploration. In some embodiments, the exploration parameters can include a target exploration point and a working frequency set. There may be a plurality of target exploration points within the target road section.

The target exploration point refers to the road section unit that needs underground exploration. The working frequency set refers to the electromagnetic wave frequency combination adopted by the GPR when performing exploration.

In some embodiments, the management platform may determine the exploration parameters based on the collapse risk distribution through the preset rules.

In some embodiments, the preset rules may be preset. For example, the management platform, based on the collapse risk distribution, determines the road section units with a collapse risk greater than a risk threshold as the target exploration points, and determines the working frequency set based on the relationship between the quantity of the target exploration points and the preset quantity. If the quantity of the target exploration points within the target road section is greater than the preset quantity, the working frequency set may adopt a combination of high-frequency, medium-frequency, and low-frequency electromagnetic waves. If the quantity of the target exploration points is not greater than the preset quantity, the working frequency set may adopt a combination of high-frequency and medium-frequency electromagnetic waves. The preset quantity is preset based on historical experience.

In some embodiments, the management platform may also determine the target exploration point based on the collapse risk distribution, the surface settlement pattern of the target road section, and abnormal surface features, and generate an exploration task list based on the target exploration point. The management platform can generate a plurality of candidate exploration paths based on the exploration task list and determine the target exploration path from the plurality of candidate exploration paths based on the traffic load data and the service priority of the target exploration point.

The surface settlement pattern may be used to characterize the morphology or trend of the surface deformation data of the target road section over time and space. In some embodiments, the surface settlement pattern includes the time pattern and the spatial pattern. The time pattern characterizes the trend of the settlement, including the stable settlement rate, the accelerating settlement rate, and the decelerating settlement rate. The spatial pattern characterizes the morphology of the settlement, including funnel-shaped or sheet-shaped.

In some embodiments, the management platform may obtain the surface deformation data of the target road section based on the two time points closest to a current time point (referred to as a first time point and a second time point, wherein the first time point is later than the second time point), and determine the difference between the settlement rate of the second time point and the settlement rate of the first time point. If the absolute value of the difference is not greater than the rate threshold, the settlement rate is stable. If the difference is positive and greater than the rate threshold, the settlement rate is decelerating. If the difference is negative and the absolute value is greater than the rate threshold, the settlement rate is accelerating. The rate threshold is preset based on historical experience.

In some embodiments, the management platform may plot a settlement plane along the orientation of the target road section based on the surface deformation data of the target road section obtained multiple times, determine the settlement morphology occurring in the target road section according to the settlement plan, and further determine the spatial pattern. The settlement plane may characterize the changes in the settlement displacement value and the settlement rate along the orientation of the target road section.

Illustratively, if there is a distinct settlement center in the settlement plane, and the settlement displacement value gradually decreases from the settlement center outwards, the spatial pattern may be funnel-shaped.

The abnormal surface feature refers to abnormal conditions of the road surface, including road surface cracks, abnormal wet stains, and surface texture changes.

In some embodiments, the management platform may control the UAV via the emergency supervision object platform to collect a surface image of the target road section and determine the abnormal surface feature of the target road section based on the surface image. The surface image may be images of the target road section from a plurality of different angles.

In some embodiments, the management platform may identify the abnormal surface feature based on the surface image through an image recognition model (such as you Only Look Once (YOLO)).

In some embodiments, in addition to determining the road section units with a collapse risk greater than the risk threshold as the target exploration points, the management platform may also determine the target exploration point through various manners. For example, the management platform may determine the road section units with the time pattern of accelerating settlement rate as the target exploration points, and determine the road section units with abnormal surface features as the target exploration points.

The exploration task list refers to an information list related to the exploration target exploration points. For example, the exploration task list includes the identifier and coordinates of the target exploration point, and the working frequency set. The identifier and coordinates of the target exploration point are stored in the management platform.

In some embodiments, the management platform may also determine a target exploration point having a surface settlement pattern within the preset future period based on the surface deformation data through the settlement feature model, and update an exploration task list. The preset future period is preset based on historical experience, for example, the next three months.

In some embodiments, the settlement feature model may be a machine learning model. For example, the settlement feature model may include any one or a combination of an RNN model, a ConvLSTM model, or other custom model structures.

In some embodiments, an input of the settlement feature model includes the surface deformation data corresponding to a plurality of road section units, and an output includes the possibility that each road section unit has the surface settlement pattern. For example, the possibility is represented by a value from 0 to 1.

In some embodiments, the management platform may train the settlement feature model based on a plurality of first training samples with the first label by using a gradient descent manner or the like. The first training samples may include sample surface deformation data of a sample road section unit, and first label may be whether the sample road section unit has a pavement collapse.

In some embodiments, the first training samples and the first label may be obtained based on historical data. For example, the management platform takes historical surface deformation data of historical road section units as the first training samples, and determines the first label based on whether a pavement collapse occurs within a period of time (e.g., three months) thereafter for historical road section units corresponding to a group of similar historical surface deformation data in the first training samples. For example, the management platform takes the ratio of the number of pavement collapses that occurred to the number of non-pavement collapses of historical road section units corresponding to each group of similar historical surface deformation data as the label corresponding to the group.

In some embodiments, the settlement feature model may be trained in the following manner: a plurality of the first training samples with the first label are input into an initial settlement feature model; a loss function is constructed by using the first label and a prediction result of the initial settlement feature model; the initial settlement feature model is iteratively updated based on the loss function; and the training of the settlement feature model is completed when a preset condition is met. The preset condition may be convergence of the loss function, the number of iterations reaching a set value, or the like.

In some embodiments, based on the possibility that a plurality of road section units output by the settlement feature model have the surface settlement pattern, the management platform may determine the road section units whose possibility is higher than a possibility threshold (For example, 0.7) as target exploration points having the surface settlement pattern within the preset future period, and add the road section units to the exploration task list. The possibility threshold is determined based on empirical prediction.

Some embodiments of the present disclosure, by proactively screening the surface deformation data through the settlement feature model, achieve a large-scale, low-cost risk census capability, thereby enhancing the comprehensiveness and foresight of risk monitoring.

The candidate exploration path refers to an exploration path to be determined. The exploration path refers to a route for the GPR to perform exploration on the target exploration point.

In some embodiments, the management platform may determine a plurality of candidate exploration paths based on the exploration task list by using an enumeration manner.

The service priority refers to an indicator that characterizes the importance and urgency of the target exploration point. In some embodiments, the service priority of the target exploration point may be the same as a collapse risk of the target exploration point or determined based on the location of the target exploration point. For example, the service priority of a target exploration point located above a main urban road or a main gas pipeline is much higher than the service priority of a target exploration point above a remote path.

The target exploration path refers to the finally determined exploration path.

In some embodiments, the management platform may determine a time cost and a priority cost corresponding to each of a plurality of candidate exploration paths based on the traffic load data and the service priority and determine the candidate exploration path with the lowest weighted sum of the time cost and the priority cost as the target exploration path. A weight of the time cost and a weight of the priority cost are preset based on historical experience.

In some embodiments, the management platform may take an average value of the vehicle travel speed in the traffic load data as a moving speed of the GPR, and determine a distance required for the GPR to traverse all of the target exploration points in the candidate exploration path, and take a ratio of the distance to the moving speed as a time cost of the candidate exploration path.

In some embodiments, for each target exploration point in the candidate exploration path, the management platform may determine a product of the service priority of the target exploration point and a duration for the GPR to reach the target exploration point from a starting point, to obtain a priority cost of the target exploration point. The management platform adds the priority cost of each target exploration point to obtain the priority cost of the candidate exploration path.

Some embodiments of the present disclosure, after determining a plurality of target exploration points, dynamically plan the target exploration path by comprehensively evaluating the traffic load data and the service priority, which can ensure that limited exploration resources can be preferentially allocated to important and urgent areas.

Step 240, controlling the GPR of the emergency supervision object platform to perform exploration on the target exploration point based on the exploration parameters, and obtaining the exploration data.

In some embodiments, the management platform controls the GPR to travel to the target exploration point in the exploration parameters via the emergency supervision object platform and controls the GPR to perform exploration on the target exploration point by using the working frequency set in the exploration parameters and return the exploration data to the management platform.

The exploration data may be two-dimensional or three-dimensional radar images collected by the GPR.

Step 250, determining whether geological hazard features exist at the target exploration point based on the exploration data.

The geological hazard features refer to geological features related to a potential pavement collapse. In some embodiments, the geological hazard features may include underground cavities, loose soil, abnormal water-bearing zones (where a large amount of accumulated water exists under the pavement), or the like.

In some embodiments, the management platform may perform preprocessing and computer vision algorithm analysis based on the exploration data to identify whether abnormal regions exist in the exploration data, thereby determining whether geological hazard features exist at the target exploration point. A region in the exploration data where reflection signals are strong and boundaries are clear may be identified as underground cavities, a region where reflection signals are discontinuous may be identified as loose soil, and a region where reflection signals are abnormally strong and water pipes exist can be identified as abnormal water-bearing zones. Strong reflection signals may mean that the waveforms of the reflection signals are clear and have complete peaks and troughs. Abnormally strong reflection signals may mean that the peaks and troughs of the waveforms of the reflection signals are flattened, thereby forming a platform.

Step 260, in response to determining that the geological hazard features exist at the target exploration point, generate a traffic control instruction and send the traffic control instruction to the emergency supervision object platform to control a barrier gate of an associated road of the target exploration point to rise.

In some embodiments, the traffic control instruction may include the associated road of the target exploration point. After receiving the traffic control instruction, the emergency supervision object platform may control the barrier gate of the associated road to rise.

The associated road refers to a road related to the target exploration point and needs to be temporarily closed. In some embodiments, the management platform may determine roads connected to the target exploration point as the associated roads.

Some embodiments of the present disclosure, by integrating the multi-source monitoring data to perform collapse risk evaluation, and based on an evaluation result, dynamically optimize the exploration parameters of the GPR to achieve accurate and efficient geological hazard detection. This approach can timely detect potential risks, automatically generate and execute traffic control instruction, effectively prevent pavement collapse accidents, and significantly enhance the safety of urban roads and an emergency response capability.

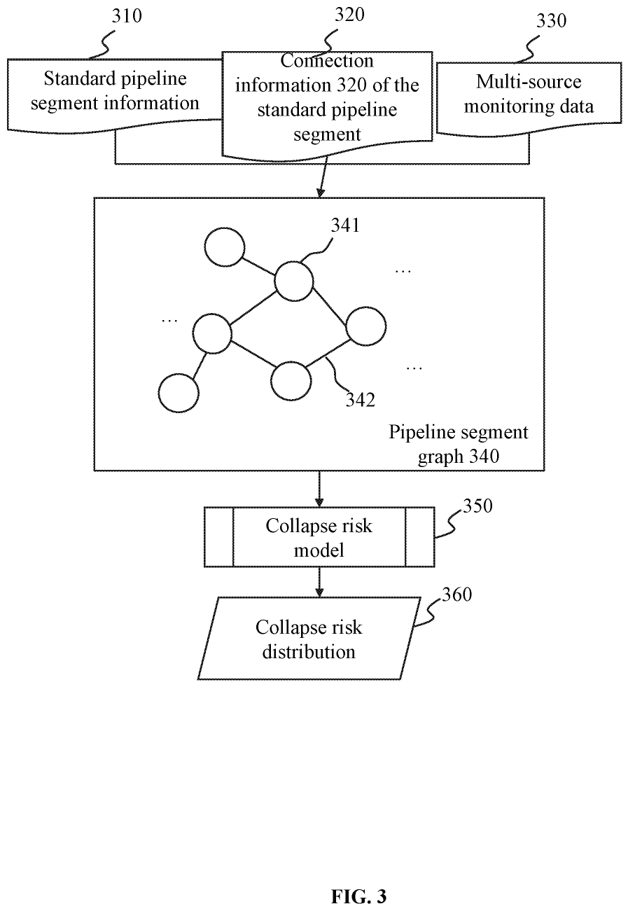

FIG. 3 is a schematic diagram illustrating an exemplary collapse risk model according to some embodiments of the present disclosure.

In some embodiments, as shown in FIG. 3, the emergency supervision management platform may construct a pipeline segment graph 340 based on standard pipeline segment information 310, connection information 320 of a standard pipeline segment, and multi-source monitoring data 330, and determine a collapse risk distribution 360 based on the pipeline segment graph 340 through a collapse risk model 350.

More descriptions of the standard pipeline segment, the multi-source monitoring data, and the collapse risk distribution may be found in FIG. 2 and its related descriptions.

The standard pipeline segment information refers to information related to a standard pipeline segment, such as the material of the standard pipeline segment, the pipe diameter, and a corresponding spatial pattern. More descriptions of the spatial pattern may be found in step 230 and its related descriptions.

The connection information of the standard pipeline segment refers to information related to the connection of the standard pipeline segment. In some embodiments, the connection information includes a physical connection relationship between standard pipeline segments, an upstream-downstream relationship, and shared manhole information. The physical connection relationship includes whether the standard pipeline segments are connected through the shared manholes. The shared manhole may be a manhole jointly connected by two standard pipeline segments. The shared manhole information includes an identification number of the shared manhole, coordinates, and a last inspection time.

The standard pipeline segment information and connection information are pre-stored in the emergency supervision management platform.

The pipeline segment graph refers to a graph structure composed of at least one node and edges between the nodes, for characterizing features of a plurality of standard pipeline segments and their connection relationships.

In some embodiments, the emergency supervision management platform may use a standard pipeline segment as a node in the pipeline segment graph (e.g., a node 341). If two standard pipeline segments are connected through a shared manhole, then an edge exists between two nodes corresponding to the two standard pipeline segments (e.g., an edge 342). The node features include standard pipeline segment information and multi-source monitoring data. Edge features include an upstream-downstream relationship and shared manhole information.

In some embodiments, the collapse risk model may be a machine learning model. For example, the settlement feature model may include a graph neural network (GNN) model or any one or a combination of other customized model structures.

In some embodiments, an input of the collapse risk model includes the pipeline segment graph, and an output includes the collapse risk of each node in the pipeline segment graph. The emergency supervision management platform determines the collapse risk distribution based on the collapse risk of each node in the pipeline segment graph.

In some embodiments, the emergency supervision management platform may train the collapse risk model based on a plurality of second training samples with second labels, through gradient descent or the like. The second training sample may include a sample pipeline segment graph, and a second label may be the collapse risk of a plurality of nodes in the sample pipeline segment graph.

In some embodiments, the second training samples and the second labels may be obtained based on historical data. For example, the emergency supervision management platform may construct the sample pipeline segment graph based on historical standard pipeline segment information, historical connection information of historical standard pipeline segments, and historical multi-source monitoring data. The collapse risk of nodes where pavement collapse occurs in the sample pipeline segment graph is 1, and the collapse risk of nodes where pavement collapse does not occur is 0.

In some embodiments, a training process of the collapse risk model is similar to the training process of the settlement feature model, which will not be described in detail herein.

Some embodiments of the present disclosure effectively extract connection relationships and features of a pipeline network by constructing a pipeline segment graph that includes standard pipeline segment information, connection information, and multi-source monitoring data, and accurately determine the collapse risk of each pipeline segment through a machine learning model, thereby significantly improving the accuracy of pavement collapse prediction.

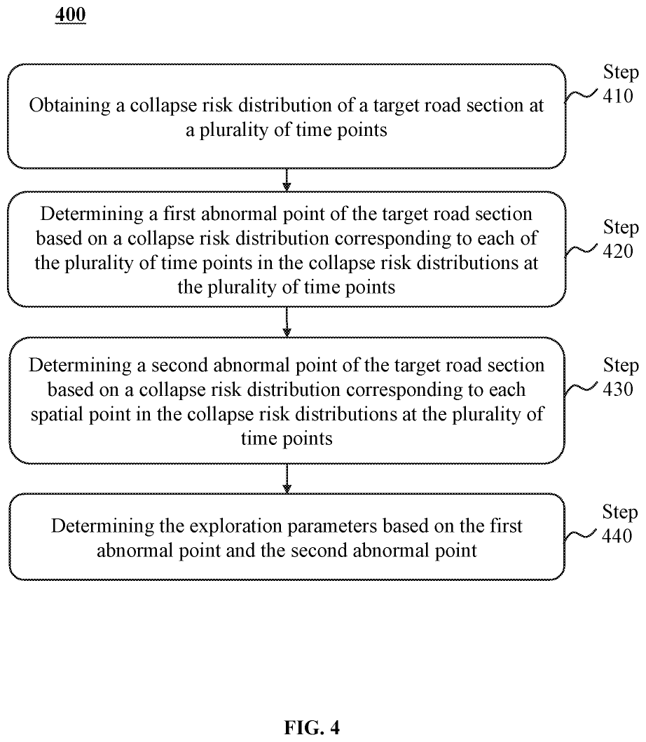

FIG. 4 is a schematic diagram illustrating an exemplary process for determining exploration parameters according to some embodiments of the present disclosure. In some embodiments, as shown in FIG. 4, the process 400 for determining exploration parameters includes the following steps:

Step 410, obtaining a collapse risk distribution of a target road section at a plurality of time points.

More descriptions of the target road section and the collapse risk distribution may be found in FIG. 2 and related descriptions. The plurality of time points include time points for obtaining a current collapse risk distribution and a historical collapse risk distribution.

Step 420, determining a first abnormal point of the target road section based on a collapse risk distribution corresponding to each of the plurality of time points in the collapse risk distributions at the plurality of time points.

The first abnormal point refers to a road section unit where collapse risk presents a spatial aggregation.

In some embodiments, the emergency supervision management platform, based on the collapse risk distribution corresponding to each of the plurality of time points in the collapse risk distributions at the plurality of time points, identifies a road section unit (namely, a target exploration point) where the collapse risk is greater than a risk threshold. If the target exploration point presents an aggregation phenomenon (e.g., target exploration points exceeding a preset aggregation quantity are mutually adjacent road section units), the emergency supervision management platform determines the target exploration points presenting the aggregation phenomenon as the first abnormal point of the target road section. The preset aggregation quantity is preset based on historical experience.

Step 430, determining a second abnormal point of the target road section based on a collapse risk distribution corresponding to each spatial point in the collapse risk distributions at the plurality of time points.

The spatial point corresponds to a road section unit.

The second abnormal point refers to a road section unit where collapse risk presents a gradual increase over time.

In some embodiments, the emergency supervision management platform is based on the collapse risk of the plurality of time points corresponding to each spatial point in the collapse risk distributions at the plurality of time points. The emergency supervision management platform determines a spatial point, where the collapse risk continuously increases with the plurality of time points and an increase amplitude of the collapse risk of adjacent time points exceeds an amplitude threshold, as the second abnormal point. The amplitude threshold is preset based on historical experience.

Step 440, determining the exploration parameters based on the first abnormal point and the second abnormal point.

More descriptions of the exploration parameters may be found in FIG. 2 and related descriptions.

In some embodiments, the emergency supervision management platform may designate the road section units determined as the first abnormal point and the second abnormal point as target exploration points and determine different working frequency sets for the different target exploration points. For example, if the target exploration point simultaneously has the first abnormal point and the second abnormal point, the working frequency set includes a combination of high-frequency, mid-frequency, and low-frequency electromagnetic waves. If the target exploration point only has the first abnormal point, the working frequency set includes a combination of mid-frequency and low-frequency electromagnetic waves. If the target exploration point only has the second abnormal point, the working frequency set includes a combination of high-frequency and mid-frequency electromagnetic waves.

Some embodiments of the present disclosure, by performing a comprehensive analysis of the spatial aggregation and a temporal trend of the collapse risk distribution, can accurately lock down a core exploration area having the highest risk from dynamic data, effectively filter out static or isolated abnormal signals, and make the positioning of the exploration target more accurate.

It should be noted that the descriptions of the process 200 for emergency supervision of pavement collapse in the smart city and the process 400 for determining exploration parameters are merely for illustration and description, and do not limit the scope of application of the present disclosure. For those skilled in the art, various modifications and changes can be made to the above-described processes under the guidance of the present disclosure. However, these modifications and changes are still within the scope of the present disclosure.

In some embodiments, the emergency supervision management platform may determine a risk level of the target road section based on the first abnormal point and the second abnormal point and determine the exploration parameters based on the risk level.

The risk level refers to a level division for evaluating the collapse risk of the target road section. For example, the risk level includes a first risk level, a second risk level, and a third risk level. The first risk level may correspond to the target road section simultaneously having the first abnormal point and the second abnormal point. The second risk level may correspond to the target road section only having the first abnormal point or the second abnormal point. The third risk level may correspond to the target road section having no first abnormal point and no second abnormal point.

In some embodiments, the emergency supervision management platform may determine the exploration parameters based on the risk level. For example, if the risk level is the first risk level or the second risk level, the working frequency set includes a combination of high-frequency, mid-frequency, and low-frequency electromagnetic waves. If the risk level is the third risk level, the working frequency set includes high-frequency electromagnetic waves to explore the shallow subsurface.

In some embodiments, when the risk level is the first risk level, the emergency supervision management platform generates traffic warning instruction and sends the traffic warning instruction to the emergency supervision object platform to control a warning device of the associated road to issue warning information. For example, the emergency supervision object platform controls, based on the traffic warning instruction, a display screen to display the warning information or controls a broadcasting equipment to play the warning information. More descriptions of the warning device may be found in FIG. 1 and related descriptions. More descriptions of the associated road may be found in Step 260 and related descriptions.

The warning information is used to remind the driver that the target road section may experience collapse.

In some embodiments, when the risk level is the second risk level, the emergency supervision management platform determines a load limit value and a height limit value of the target road section based on historical load data and a collapse risk distribution at a current time point and generates a load limiting instruction and a height limiting instruction. The emergency supervision management platform sends the load limiting instruction and the height limiting instruction to the emergency supervision object platform to control the warning device to issue load limiting information and control the height of the height limiting frame of the associated road. For example, the emergency supervision object platform may control, based on the load limiting instruction and the height limiting instruction, a display screen to display the load limiting information in the load limiting instruction, or control a broadcasting equipment to play the load limiting information, and control the height of the height limiting frame of the associated road to be adjusted to be the same as the height limit value in the height limiting instruction.

The historical load data refers to traffic load data of the target road section at historical time. More descriptions of the traffic load data may be found in Step 210 and related descriptions.

In some embodiments, the emergency supervision management platform may determine, based on the collapse risk distribution at a current time point, a sum value of the collapse risk of a plurality of road section units in the target road section, and determine the load limit value and the height limit value of the target road section based on the obtained sum value and historical load data. The load limit value and the height limit value are negatively correlated with the obtained sum value and positively correlated with historical load data.

The load limiting information is used to remind the driver of the load limit value of the target road section, for example, ‘The road section ahead is limited to 30 tons’.

In some embodiments, when the risk level is the second risk level, the emergency supervision management platform controls an UAV via the emergency supervision object platform to obtain a surface image of the target road section, and based on the surface image, determines abnormal surface features of the target road section. If the target road section has abnormal surface features, the emergency supervision management platform corrects the risk level corresponding to the target road section from the second risk level to the first risk level. More descriptions of the surface image and the abnormal surface features may be found in Step 230 and related descriptions.

Some embodiments of the present disclosure can timely adjust the risk level of the target road section according to intuitive surface features, which significantly improves the accuracy of risk determination.

In some embodiments, when the risk level is the third risk level, the emergency supervision management platform, based on the collapse risk of the target exploration point, determines an exploration cycle and generates a periodic exploration plan. The emergency supervision management platform sends the periodic exploration plan to the emergency supervision object platform and controls the GPR to perform exploration on the target exploration point based on the periodic exploration plan.

The exploration cycle refers to a time interval for performing repeated exploration on the target exploration point. The periodic exploration plan includes the coordinates of each target exploration point and the corresponding exploration cycle, or the like.

In some embodiments, the emergency supervision management platform determines the exploration cycle based on the collapse risk of the target exploration point. For example, the greater the collapse risk, the shorter the exploration cycle.

Some embodiments of the present disclosure can automatically execute differentiated management measures, such as warning and guidance, traffic load limiting, and periodic exploration, according to the severity of the collapse risk of the target road section. This hierarchical response mechanism realizes fine-grained utilization of public resources, enables decisive handling of emergency hazards, and implements long-term management of potential hazards, thereby ensuring the rationality of emergency supervision and a reduction in economic costs.

Furthermore, certain features, structures, or characteristics in one or more embodiments of the present disclosure may be suitably combined.

Accordingly, in some embodiments, the numerical parameters used in the description and claims are approximate values, and the approximate values may be changed according to desired characteristics of individual embodiments. In some embodiments, numerical parameters should consider specified significant digits and adopt a general manner of rounding. Although the numerical ranges and parameters used in some embodiments of the present disclosure to confirm the breadth of its scope are approximate values, in specific embodiments, the setting of such numerical values is as precise as possible within a practicable range.

If the descriptions, definitions, and/or use of terms in cited materials of the present disclosure are inconsistent or in conflict with the content described in the present disclosure, the descriptions, definitions, and/or use of terms of the present disclosure shall prevail.

What is claimed is:

1. An Internet of Things large model system for emergency supervision of pavement collapse in a smart city, comprising: an emergency supervision user platform, an emergency supervision service platform, an emergency supervision management platform, an emergency supervision sensor network platform, and an emergency supervision object platform; wherein the emergency supervision management platform is configured to:
obtain multi-source monitoring data via the emergency supervision object platform;
determine a collapse risk distribution of a target road section based on the multi-source monitoring data;
determine exploration parameters based on the collapse risk distribution, and the exploration parameters include a target exploration point and a working frequency set;
control a vehicle-mounted ground penetrating radar (GPR) of the emergency supervision object platform to perform exploration on the target exploration point based on the exploration parameters and obtain exploration data;
determine whether geological hazard features exist at the target exploration point based on the exploration data; and
in response to determining that the geological hazard features exist at the target exploration point, generate a traffic control instruction and send the traffic control instruction to the emergency supervision object platform to control a barrier gate of an associated road of the target exploration point to rise.

2. The IoT large model system of claim 1, wherein the multi-source monitoring data includes surface deformation data, and the surface deformation data includes a settlement displacement value and a settlement rate.

3. The IoT large model system of claim 2, wherein the emergency supervision management platform is further configured to:
determine a target exploration point having a surface settlement pattern within a preset future period based on the surface deformation data through a settlement feature model and update an exploration task list.

4. The IoT large model system of claim 1, wherein the emergency supervision management platform is further configured to:
determine historical collapse cases based on historical disaster data, road monitoring data, and a road construction log; and
determine the target road section based on the historical collapse cases.

5. The IoT large model system of claim 1, wherein the emergency supervision management platform is further configured to:
determine the target exploration point based on the collapse risk distribution, a surface settlement pattern of the target road section, and abnormal surface features;
generate an exploration task list based on the target exploration point;
generate a plurality of candidate exploration paths based on the exploration task list; and
determine a target exploration path from the plurality of candidate exploration paths based on traffic load data and a service priority of the target exploration point.

6. The IoT large model system of claim 1, wherein the emergency supervision management platform is further configured to:
construct a pipeline segment graph based on standard pipeline segment information, connection information of a standard pipeline segment, and the multi-source monitoring data; the pipeline segment graph including at least one node and edges between nodes, the at least one node having node features, the at least one node and the node features being determined based on the multi-source monitoring data, the standard pipeline segment information, and the connection information; the edges having edge features, the edges and the edge features being determined based on the standard pipeline segment information and the connection information; and
determine the collapse risk distribution based on the pipeline segment graph through a collapse risk model, and the collapse risk model is a machine learning model.

7. The IoT large model system of claim 1, wherein the emergency supervision management platform is further configured to:
obtain collapse risk distributions of the target road section at a plurality of time points;
determine a first abnormal point of the target road section based on a collapse risk distribution corresponding to each of the plurality of time points in the collapse risk distributions at the plurality of time points;
determine a second abnormal point of the target road section based on a collapse risk distribution corresponding to each spatial point in the collapse risk distributions at the plurality of time points; and
determine the exploration parameters based on the first abnormal point and the second abnormal point.

8. The IoT large model system of claim 7, wherein the emergency supervision management platform is further configured to:
determine a risk level of the target road section based on the first abnormal point and the second abnormal point, wherein the risk level includes a first risk level, a second risk level, and a third risk level; and
determine the exploration parameters based on the risk level.

9. The IoT large model system of claim 8, wherein the emergency supervision management platform is further configured to:
when the risk level is the first risk level, generate a traffic warning instruction and send the traffic warning instruction to the emergency supervision object platform to control a warning device of the associated road to issue warning information;
when the risk level is the second risk level,
determine a load limit value and a height limit value of the target road section based on historical load data and a collapse risk distribution at a current time point, and generate a load limiting instruction and a height limiting instruction;
send the load limiting instruction and the height limiting instruction to the emergency supervision object platform to control the warning device to issue load limiting information and control a height of a height limiting frame of the associated road;
when the risk level is the third risk level,
determine an exploration cycle and generate a periodic exploration plan based on a collapse risk of the target exploration point; and
send the periodic exploration plan to the emergency supervision object platform to control the vehicle-mounted ground penetrating radar (GPR) to perform exploration on the target exploration point based on the periodic exploration plan.

10. The IoT large model system of claim 8, wherein the emergency supervision management platform is further configured to:
when the risk level is the second risk level, control an unmanned aerial vehicle (UAV) via the emergency supervision object platform to obtain a surface image of the target road section;
determine an abnormal surface feature of the target road section based on the surface image; and
correct the risk level to the first risk level based on the abnormal surface feature.

11. A method for emergency supervision of pavement collapse in a smart city, wherein the method is performed by an emergency supervision management platform in an Internet of Things large model system for emergency supervision of pavement collapse in a smart city, comprising:
obtaining multi-source monitoring data via an emergency supervision object platform;
determining a collapse risk distribution of a target road section based on the multi-source monitoring data;
determining exploration parameters based on the collapse risk distribution, and the exploration parameters include a target exploration point and a working frequency set;
controlling a vehicle-mounted ground penetrating radar (GPR) of the emergency supervision object platform to perform exploration on the target exploration point based on the exploration parameters and obtain exploration data;
determining whether geological hazard features exist at the target exploration point based on the exploration data; and
in response to determining that the geological hazard features exist at the target exploration point, generating a traffic control instruction and sending the traffic control instruction to the emergency supervision object platform to control a barrier gate of an associated road of the target exploration point to rise.

12. The method of claim 11, wherein the multi-source monitoring data includes surface deformation data, and the surface deformation data includes a settlement displacement value and a settlement rate.

13. The method of claim 12, further comprising:
determining, based on the surface deformation data and through the settlement feature model, a target exploration point having a surface settlement pattern within a preset future period, and updating an exploration task list.

14. The method of claim 11, further comprising:
determining historical collapse cases based on historical disaster data, road monitoring data, and a road construction log; and
determining the target road sections based on the historical collapse case.

15. The method of claim 11, further comprising:
determining the target exploration point based on the collapse risk distribution, the surface settlement pattern of a target road section, and abnormal surface features;
generating the exploration task list based on the target exploration point;
generating a plurality of candidate exploration paths based on the exploration task list; and
determining a target exploration path from the plurality of candidate exploration paths based on traffic load data and a service priority of the target exploration point.

16. The method of claim 11, wherein determining a collapse risk distribution of a target road section based on the multi-source monitoring data includes:
constructing a pipeline segment graph based on standard pipeline segment information, connection information of a standard pipeline segment, and the multi-source monitoring data; the pipeline segment graph including at least one node and edges between nodes, the at least one node having node features, the at least one node and the node features being determined based on the multi-source monitoring data, the standard pipeline segment information, and the connection information; the edges having edge features, the edges and the edge features being determined based on the standard pipeline segment information and the connection information; and
determining the collapse risk distribution through a collapse risk model based on the pipeline segment graph, and the collapse risk model is a machine learning model.

17. The method of claim 11, wherein determining exploration parameters based on the collapse risk distribution includes:
obtaining collapse risk distributions of the target road section at a plurality of time points;
determining a first abnormal point of the target road section based on a collapse risk distribution corresponding to each of the plurality of time points in the collapse risk distributions at the plurality of time points;
determining a second abnormal point of the target road section based on a collapse risk distribution corresponding to each spatial point in the collapse risk distributions at the plurality of time points; and
determining the exploration parameters based on the first abnormal point and the second abnormal point.

18. The method of claim 17, further comprising:
determining a risk level of the target road section based on the first abnormal point and the second abnormal point, and the risk level includes a first risk level, a second risk level, and a third risk level; and
determining the exploration parameters based on the risk level.

19. The method of claim 18, further comprising:
when the risk level is the first risk level, generating a traffic warning instruction, sending the traffic warning instruction to the emergency supervision object platform, and controlling a warning device of the associated road to issue warning information;
when the risk level is the second risk level,
determining a load limit value and a height limit value of the target road section based on historical load data and a collapse risk distribution at a current time point, and generating a load limiting instruction and a height limiting instruction;
sending the load limiting instruction and the height limiting instruction to the emergency supervision object platform, controlling the warning device to issue load limiting information, and controlling a height of a height limiting frame of the associated road;
when the risk level is the third risk level,
determining an exploration cycle and generating a periodic exploration plan based on a collapse risk of the target exploration point; and
sending the periodic exploration plan to the emergency supervision object platform, and controlling the vehicle-mounted ground penetrating radar (GPR) to perform exploration on the target exploration point based on the periodic exploration plan.

20. The method of claim 18, further comprising:
when the risk level is the second risk level, controlling, through the emergency supervision object platform, an unmanned aerial vehicle (UAV) to collect a surface image of the target road section;
determining the abnormal surface feature of the target road section based on the surface image; and
correcting the risk level to the first risk level based on the abnormal surface feature.
